(19) United States
(12) Patent Application Publication
(10) Pub. No.: US 2013/0142954 A1
(43) Pub. Date: Jun. 6, 2013

(54) SILICONIZING APPARATUS AND METHOD

(71) Applicant: SGL Carbon Se, Wiesbaden (DE)

(72) Inventors: CHRISTIAN BRUCH, Gersthofen-Hirlinger (DE); JOHANN DAIMER, MOERFELDEN-WALLDORF (DE)

(73) Assignee: SGL CARBON SE, MEITINGEN (DE)

(21) Appl. No.: 13/758,484

(22) Filed: Feb. 4, 2013

Related U.S. Application Data
(63) Continuation of application No. PCT/EP2011/059888, filed on Jun. 15, 2011.

(30) Foreign Application Priority Data
Aug. 4, 2010 (DE) 10 2010 038 914.5

(51) Int. Cl. B05C 9/12

(52) U.S. Cl. CPC B05C 9/12
USPC 427/331; 118/600

(57) ABSTRACT

An apparatus for siliconizing carbon-containing workpieces has a chamber with an inlet, a siliconizing device inside, and an outlet. A transporting device has a fixed holding part that extends from the inlet to the siliconizing device and from there to the outlet, and a transporting part with two beams that can move in parallel. The holding and transporting parts have pairs of slots opposite one another with respect to a longitudinal axis L of the transporting device and configured for receiving a rod or the workpiece. The transporting part can be driven to execute a repeated cycle of movements that includes a lifting movement, an advancing movement and a lowering movement, in order to move rods that are resting on the holding part in a cyclical manner along the longitudinal axis L from the inlet to the siliconizing device and from there to the outlet.

### CROSS-REFERENCE TO RELATED APPLICATION

This is a continuation application, under 35 U.S.C. §120, of copending international application No. PCT/EP2011/059888, filed Jun. 15, 2011, which designated the United States; this application also claims the priority, under 35 U.S.C. §119, of German patent application No. DE 10 2010 038 914.5, filed Aug. 4, 2010; the prior applications are herewith incorporated by reference in their entirety.

### BACKGROUND OF THE INVENTION

### Field of the Invention

The invention relates to an apparatus and a method for siliconizing carbon-containing workpieces.

The process for siliconizing materials is a finishing process which provides carbon-containing workpieces with increased stability. The base reaction is the fusing of carbon and silicon within the workpiece to form silicon carbide.

An example of a method for siliconizing materials containing carbon is described in Patent No. U.S. Pat. No. 6,221,475 B1 and its counterpart published European patent application EP 0 956 276 A1. According to that method, the carbon-containing material to be siliconized combined with powdered silicon is heated so that the molten silicon penetrates into the material and reacts within it, at least to a certain extent, to form silicon carbide. However, that method can only be carried out in batches, which limits the large-scale use of the method.

An improvement thereto is proposed in Patent No. U.S. Pat. No. 7,763,224 B2 and its counterpart German patent DE 10 2006 009 388 B4. The method disclosed in that document is distributed over several chambers in which particular temperature and pressure conditions prevail. The workpiece to be siliconized is then positioned consecutively in the respective chambers to heat it up, to react with the silicon and to cool it down. Once the workpiece has been conveyed from one chamber into the next, a fresh workpiece can then be introduced into the first chamber. This means that the throughput is improved, but only to a limited extent.

### SUMMARY OF THE INVENTION

It is accordingly an object of the invention to provide an apparatus and a siliconizing method which overcome the above-mentioned disadvantages of the heretofore-known devices and methods of this general type and which provide for an apparatus and a method for siliconizing carbon-containing workpieces which allow the method to be conducted continuously.

With the foregoing and other objects in view there is provided, in accordance with the invention, an apparatus for siliconizing carbon-containing workpieces, the apparatus comprising:

a siliconizing device disposed inside a chamber, said chamber having an inlet and an outlet;

a conveyor device having a stationary holding part and a conveying part, said stationary holding part extending between said inlet and said siliconizing device and between said siliconizing device and said outlet, and said conveying part including two beams that are movable parallel to one another;

each of said holding part and said conveying part being formed with respective pairs of slots, with said slots of one of each pair facing one another with respect to a longitudinal axis L of said conveyor device and being configured to hold a workpiece or a rod holding the workpiece; and

wherein said conveying part is configured to be driven in a repeated cycle of movements including a lifting movement, an advancing movement, and a lowering movement in order to move rods resting on said holding part in an indexed manner along the longitudinal axis L from said inlet to said siliconizing device, and from said siliconizing device to said outlet.

With the above and other objects in view there is also provided, in accordance with the invention, a method for siliconizing (or: silicizing) carbon-containing workpieces. The method comprises:

a) placing one or more workpieces on a rod;

b) resting the rod on a pair of slots of a conveyor device, the conveyor device having a stationary holding part that extends from an inlet of a siliconizing chamber to a siliconizing device in the siliconizing chamber and from the siliconizing device to an outlet of the siliconizing chamber, and having a conveying part with two beams that can move parallel to one another;

c) conveying the rod by single or repeated lifting, advancing and lowering the rod with the conveying part on the holding part, to thereby transport the rod incrementally from the inlet into the siliconizing device;

d) siliconizing the workpiece in the siliconizing device; and

e) conveying the rod by repeated lifting, advancing and lowering the rod with the conveying part on the holding part to thereby transport the rod incrementally away from the siliconizing device to the outlet.

In accordance with one embodiment of the invention, an apparatus for siliconizing carbon-containing workpieces comprises the following: a chamber with an inlet and an outlet, inside which is a siliconizing device; as well as a conveyor device with a stationary holding part which extends between the inlet and the siliconizing device as well as between the siliconizing device and the outlet, and a conveying part, which comprises two beams which can move parallel to one another, wherein both the holding part and the conveying part comprise respective pairs of slots, wherein the slots of one of each pair face each other with respect to a longitudinal axis L of the conveyor device and are designed to accommodate a rod or the workpiece itself and wherein the conveying part can be driven in a repeated cycle of movements which comprises a lifting, advancing and lowering movement in order to move rods resting on the holding part in an indexed manner along the longitudinal axis L from the inlet to the siliconizing device, and therefrom to the outlet.

Thus, in addition to the siliconizing device, the key element of the apparatus is the specially designed conveyor device. By means of this, the workpieces which are to be treated are moved in an intermittent manner through the interior of the chamber towards the siliconizing device and then away from it again after the siliconizing process. When using the device in a method in accordance with the invention, in each cycle of movements, the workpiece or workpieces mounted on one of the rods are conveyed along the holding part in the direction of the siliconizing device and then away from the siliconizing device to the chamber outlet. In this regard, the rods or carriers or the workpiece itself, which respectively lie in a pair of slots of the holding part, are caught hold of from below by the beams of the conveying part in the lifting step of the cycle of movements. Thus, the rods are taken out of the respective pair of slots of the holding part and then rest in a pair of slots of the conveying part. In the next, advance, step, the rods resting in the slots of the beams of the conveying part are transported in the forward direction, which is defined by the sequence inlet—siliconizing device—outlet, over a pre-set distance. Next, in the lowering step, the rods are once again placed on the holding part, but this time in pairs of slots which are at a distance in the forward direction from the pair of slots in which the respective rod was originally placed, for example in the respectively adjacent pair of slots in the forward direction. In this manner, the rods are transported through the chamber in the forward direction in an incremental manner.

Between the individual cycles of movements there may be intervals of several minutes or even hours in which the rods and thus the workpieces on them rest on the holding part or, during this interval, those rods which have been introduced into the siliconizing device in the preceding cycle of movements undergo the siliconizing process proper before they are removed from the siliconizing device in the next cycle of movements and then transported once more along the conveyor device in the direction of the outlet. In total, then, the workpieces are in the chamber for a much longer period than the duration of this interval in which they are inside the siliconizing device, so that they can come into contact with the silicon therein for the purposes of finishing. During the duration of the described incremental progress from the inlet to the siliconizing device, the workpieces are gradually heated by the prevailing high temperatures in the chamber of 1300° C. to 1800° C., so that upon introduction into the siliconizing device, they have reached a suitable temperature. The siliconizing device itself generally constitutes the hottest part of the chamber, since it contains silicon in the molten state. However, the temperature can also be programmed such that the pre-heating temperature is set higher than the siliconizing temperature. In contrast, the workpieces cool down on their way from the siliconizing device to the chamber outlet.

In the manner described, a continuous method can be implemented by means of the device of the invention. This has the advantage that a higher throughput of workpieces per unit time can be obtained. In addition, the chamber does not have to be heated up and then cooled down again for each batch. Since the process of heating up and cooling down workpieces is carried out at least partly inside the chamber, then a sequence of multiple chambers as in the prior art is not absolutely necessary.

In order to keep the temperature and pressure conditions within the chamber stable, both the inlet and the outlet preferably are in the form of airlocks, which means that introduction or withdrawal of workpieces on the rods is possible without perturbing the conditions inside the chamber. Suitable airlocks are known in the art, and thus specific details of their construction do not need to be given here.

The conveyor device described herein make it possible to incrementally move the workpieces (hung on the rods) inside the chamber. Because the rods are exchanged between the pairs of slots of the holding part and pairs of slots of the conveying part and from pairs of slots of the conveying part to pairs of slots of the holding part during a cycle of movements by catching hold of the rods from below or lowering the rods by means of the beams of the conveying part, only a small mechanical loading arises during transport and setting down. The conveyor device itself can be constructed so as to have no moving mechanical locking parts within the region where the high temperatures prevail in the chamber. These simple mechanics mean that the conveyor device is resistant to wear under the extreme temperature conditions prevailing in the chamber. In this regard, it should be noted that all of the critical elements of the conveyor device, such as the drive, control and the like, are intentionally disposed outside the chamber, while the parts of the conveyor device which are inside the chamber are limited to the movable beams of the conveying part and the holding part. The parts of the conveyor device which are in the chamber may, for example, be produced from graphite, in particular fine-grained graphite or from CFC components, so that they can withstand the high temperatures without damage.

Not only the conveying part, but also the holding part of the conveyor device may be in the form of two beams which are parallel to each other. In contrast to the beams of the conveying part, the beams of the holding part are fixed in the chamber in a stationary manner. Both the beams of the holding part and also those of the conveying part each have pairs of slots which are arrayed next to each other along the longitudinal axis L of the conveyor device. In accordance with one embodiment of the invention, a first beam of the conveying part extends in a direction adjacent to a first beam of the holding part and a second beam of the conveying part extends in the same direction adjacent to a second beam of the holding part. In other words, one beam of the conveying part is adjacent to a beam of the holding part between the two beams of the holding part, while the second beam of the conveying part is adjacent to the other beam of the holding part outside the intermediate space defined by the beams of the holding part. This configuration has the advantage that the separation of the two slots of a pair of slots of the holding part is equal to the separation of the two slots of a pair of slots of the conveying part. In this manner, the region of each rod which is between the positions at which the rod rests within the slots is always equal, thereby keeping the loading on the rods during operation constant.

The cycle of movements may in particular be a closed cycle, which comprises, in this sequence, a lifting, an advancing, a lowering and a return movement. In this manner, the return movement of the beam of the conveying part is carried out while there are no rods on the slots of the conveying part. In this manner, the beams of the conveying part move in a quasi-rectangular movement, whereby after each cycle of movements, the starting position of the conveying part is regained. The beams of the conveying part are thus displaced in the forward direction with respect to the holding part by only a small distance; the expression “a small distance” as applied to the movement in the forward direction in each cycle is with respect to the total displacement of the rods from the inlet via the siliconizing device to the outlet. In particular, this fraction is 20%, preferably less than 10%.

In an advantageous embodiment of the invention, a first section of the holding part which extends between the inlet and the siliconizing device is disposed spatially above a second section which extends between the siliconizing inlet and the outlet. This means that the inlet and the outlet are arranged on the same side of the chamber, for example one directly below the other. The conveyor device in this embodiment initially conveys the rods in a first direction from the inlet to the siliconizing device and then from this latter downwards, and in a further step in a second direction from the siliconizing device to the outlet, wherein the second direction may, for example, lie in an anti-parallel direction to the first direction. This has the advantage that the cooling phase after the siliconizing process (second section) is carried out in a lower region than the heating phase (first section), whereupon the heat from the already siliconized workpieces can be used in an energy-saving manner to support the process of heating up the workpieces which are being introduced.

The siliconizing device may, for example, comprise a reservoir in which two roller wicks are positioned whereby the conveyor device is designed such that in one cycle of movement, a rod resting on the holding part is positioned between the roller wicks and in a subsequent cycle of movements, it is taken out again and placed on the holding part. This embodiment is of particular advantage when the workpieces are approximately circular in shape, making successive immersion of the workpieces in the molten silicon contained in the reservoir easier by rotation of the roller wicks. Clearly, other known mechanisms may be used to immerse the workpieces fed in by the conveyor device in the reservoir containing the molten silicon.

In the context of the invention, the term “workpiece” means not only finished parts, but also semi-finished products or blanks which are to undergo a siliconizing process.

The invention also concerns a method for siliconizing carbon-containing workpieces, comprising the following steps: a) placing one or more workpieces on a rod; b) resting the rod on a pair of slots of a conveyor device which comprises a stationary holding part which extends between an inlet of a siliconizing chamber and a siliconizing device therein as well as between the siliconizing device and an outlet from the siliconizing chamber, and a conveying part having two beams which can move parallel to one another; c) conveying the rod by means of single or repeated lifting, advancing and lowering thereof by means of the conveying part on the holding part, such that the rod is transported in an incremental manner from the inlet into the siliconizing device; d) siliconizing the workpiece in the siliconizing device; and e) conveying the rod by means of repeated lifting, advancing and lowering thereof by the conveying part on the holding part such that the rod is transported in an incremental manner away from the siliconizing device to the outlet.

This method is thus a continuous method when the apparatus described above is employed. Since a plurality of rods can be conveyed simultaneously using the conveyor device, inside the chamber there is always a certain number of workpieces in various stations of the process. Step a) for placing or fixing the workpiece to a rod is carried out as a rule outside the chamber, for example in an airlock, at lower temperatures than those prevailing in the siliconizing chamber, see above. With suitable geometries, the rod can be dispensed with; the workpiece can be placed directly on the conveyor device.

In steps c) and e), the cycle of movements of lifting, advancing and lowering may be identical to each other. This means that the length of the advance and the lifting or lowering height is the same in each cycle of movements. Thus, an identically profiled movement is carried out throughout the method, which means that controlling the method is advantageously simplified.

As already mentioned, the cycle of movements may be closed, which comprises a lifting, an advancing, a lowering and a return movement of the beams of the conveying part in this sequence, wherein during the return movement of the beams, the rod is accommodated in a pair of slots of the holding part. In this manner, the “standby period” during which the rods are resting on the holding part is used to return the beams of the conveying part. Moreover, in this type of movement, the beams of the conveying part are loaded to a lesser extent, since they only have to be displaced through small units of movement.

In a further embodiment, the siliconizing device contains a reservoir filled with molten silicon, wherein transport into the siliconizing device comprises lowering the workpieces placed on the rod down onto roller wicks within the reservoir. Alternatively, however, the rods may also be immersed in the siliconizing melt using another device for lowering them, or they may be placed on stationary wicks.

Step a) comprises guiding the rod through a through opening in the workpiece. In other words, the respective workpiece is “threaded” onto the rod. Depending on the dimensions of the workpiece and the rod, a plurality of workpieces may also be positioned one next to the other on a rod. In this manner, the throughput of workpieces per unit time for the method of the invention is increased. The through openings may be such that are intrinsic to the nature of the workpiece, as well as openings which are specifically located and opened up for placing them on the rod.

In order to prevent the workpiece from adhering to the rod, a sleeve of silicon-repellent material may be positioned between the rod and the workpiece. However, any other type of impregnation of the rod to counter adhesion to the workpiece is possible in order to facilitate removal of the prepared workpiece from the rod.

As already mentioned, in an alternative embodiment, step e) may be carried out spatially below the region in which step c) is carried out. In this manner, the heat from the cooling workpieces which have just passed through step e) can be used to heat up those workpieces which are in the step c) stage, i.e., moving towards the siliconization. This saves on the cost of the process.

Other features which are considered as characteristic for the invention are set forth in the appended claims.

Although the invention is illustrated and described herein as embodied in a silicizing apparatus and method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a side view of workpieces on a rod as used in the method of the invention;

FIG. 2 is a top view of a first embodiment of a device in accordance with the invention for siliconizing carbon-containing workpieces;

FIG. 3 is a side view of the embodiment of FIG. 2; and

FIG. 4 is an alternative embodiment of the apparatus of the invention.

### DETAILED DESCRIPTION OF THE INVENTION

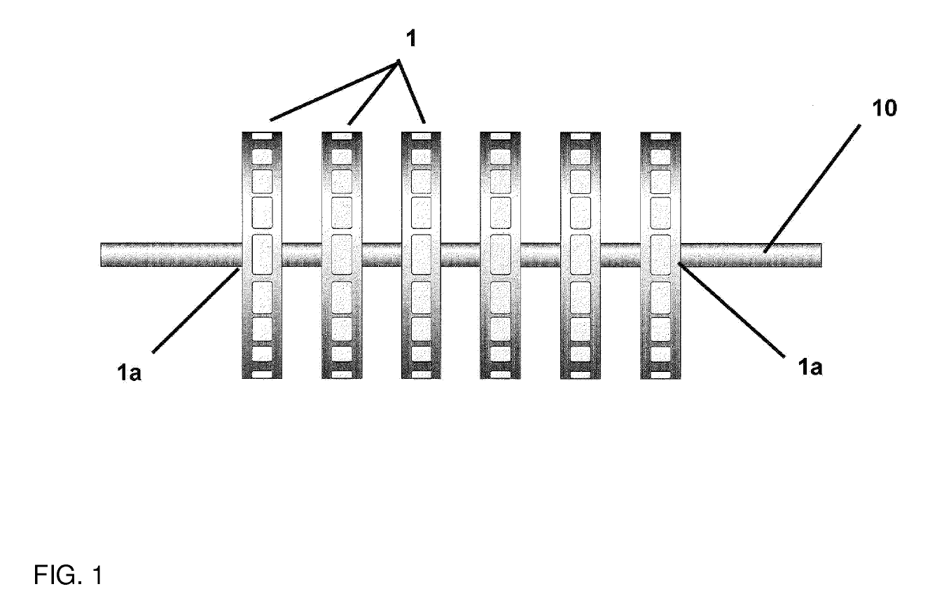

Referring now to the figures of the drawing in detail where the same reference numerals are used throughout to identify identical or functionally equivalent features and elements of various embodiments, and first, particularly, to FIG. 1 thereof, there is shown an exemplary arrangement of workpieces 1 which each have a through opening la via which they are guided onto a rod 10 or a round beam. In the embodiment shown, brake disks are provided as examples of workpieces 1 to be siliconized using the method of the invention. Clearly, however, other workpieces and semi-finished products can be given a finishing treatment using the method of the invention. Non-limiting examples thereof are plates, tubes, rods and other geometries.

In a first step a) of the method of the invention, the workpieces 1 are placed on the rod 10. In the arrangement shown here, the workpieces 1 are held securely on the rod without the need for special fixtures. In order to prevent the workpiece 1 from adhering to the rod 10 during the siliconizing process, the rod may, for example, be provided with a non-stick coating, i.e. a silicon-repellent coating, for example formed from boron nitride, silicon nitride or comparable materials.

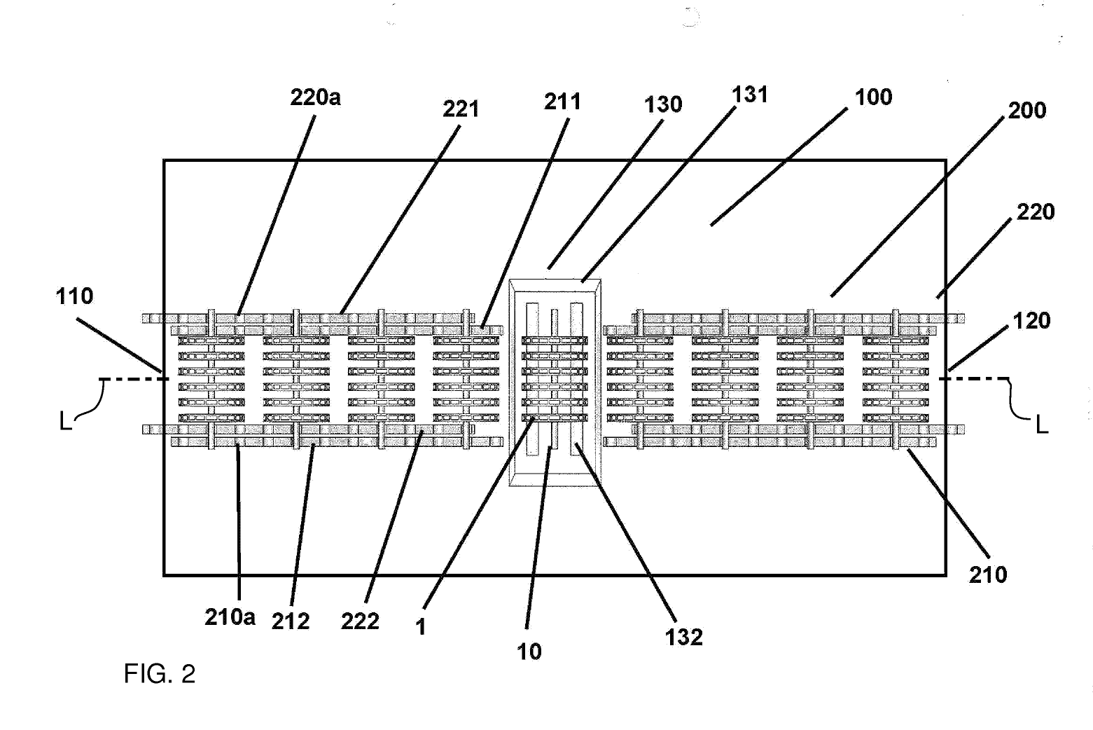

Referring now to FIG. 2, this shows a first embodiment of an apparatus in accordance with the invention in top view. The figure shows the inside of a chamber 100 which will also be described below as the siliconizing chamber, although several steps of the method are carried out therein, such as heating up and cooling down the workpieces 1 before or after the siliconizing process proper.

The chamber 100 comprises an inlet 110 and an outlet 120, which in this embodiment face each other in the chamber 100. Between the inlet 110 and the outlet 120 is a siliconizing device 130, in this case in the form of a heated reservoir 131 filled with molten silicon. It is important that this part of the chamber 100 is kept at a sufficiently high temperature for the silicon to be kept in the liquid state. Roller wicks 132 are introduced into the reservoir 131, in this case two roller wicks 132, which can be rotated about their respective axes in order to sequentially immerse the entire circumferences of the workpieces 1 in the melt (step d)).

The apparatus of the invention also comprises a conveyor device 200 which contains a holding part 210 with a first beam 211 and a second beam 212. The beams 211 and 212 are, as shown, arranged essentially parallel to each other along a longitudinal axis L of the conveyor device 200, wherein each beam 211, 212 comprises slots 210a. Each groove 210a of the first beam 211 along with a groove 210a facing it with respect to the longitudinal axis L forms a pair of slots to accommodate a rod 10.

In similar manner, a conveying part 220 of the conveyor device 200 comprises a first beam 221 and a second beam 220 which are arranged parallel to each other along the longitudinal axis L of the conveyor device 200. The first beam 221 of the conveying part 220 is disposed such that it is adjacent to the first beam 211 of the holding part 210 in a first direction (on the left in the figure). Similarly, the second beam 222 of the conveying part 220 is adjacent to the second beam 212 of the holding part 210 in the first direction (on the left in the figure). Further, the beams 221, 222 of the conveying part 220 each contain slots 220a which are arranged in pairs.

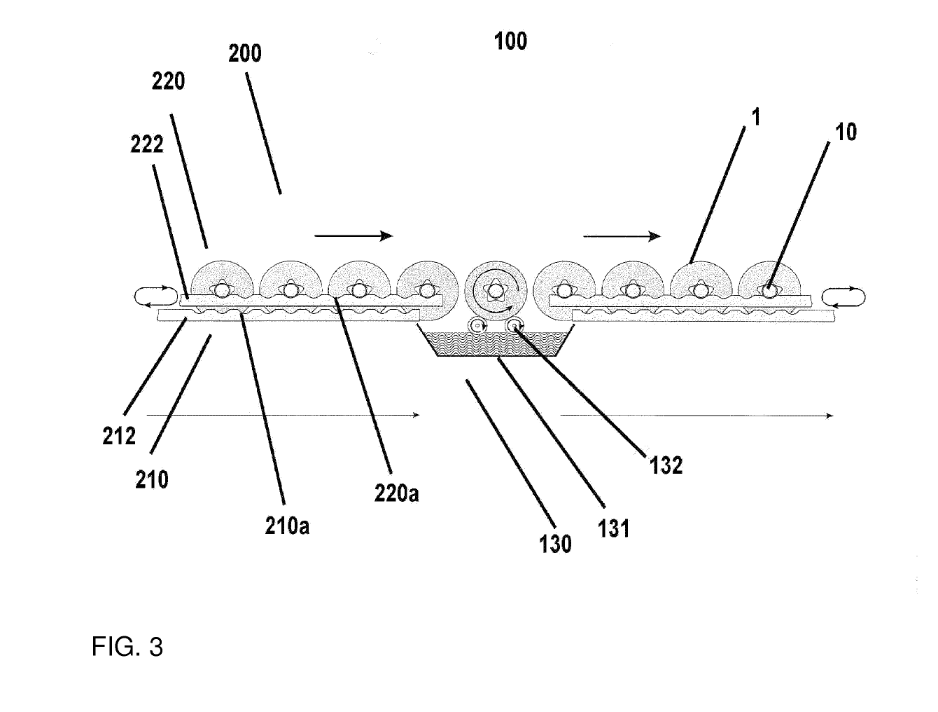

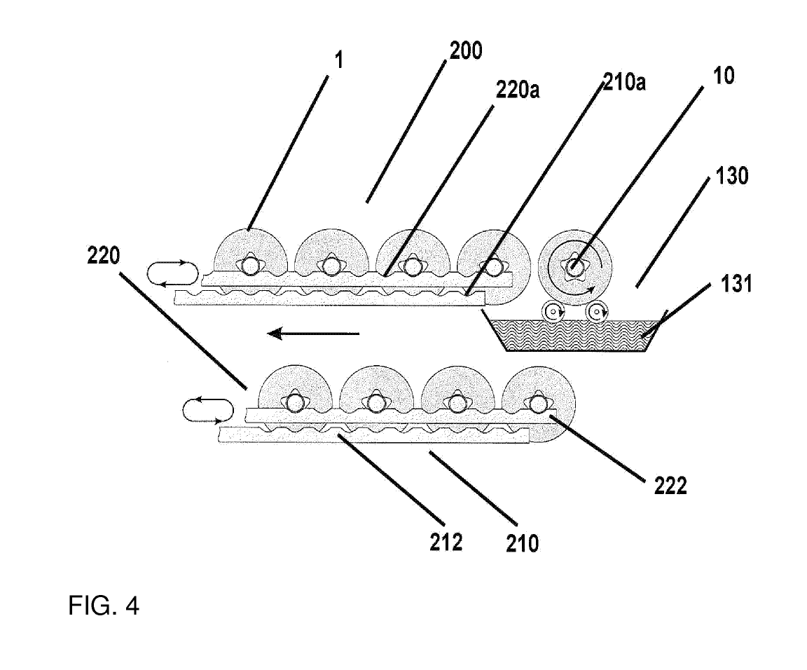

FIGS. 3 and 4 show the further course of the method of the invention after placing the workpieces 1 on the rod 10. The rods 10 in this case have already been positioned on the conveyor device 200, whereupon the step b) of positioning outside the chamber shown, 100, is carried out.

As can be seen in FIG. 3, both the holding part 210 and the conveying part 220 of the conveyor device 200 are in two sections, wherein in the first section upstream of the siliconizing device 130 (on the left in the drawing), step c) of conveying the rods 10 to the siliconizing device is carried out. As can be seen, a number of rods 10 are positioned in the conveying direction (straight arrow) adjacent to each other in the slots 220a of the beam 222 of conveying part 220, wherein the beams 222 with respect to the beams 212 of the holding part 210 are in the lifted position. Together with the beams 221 (not shown in FIGS. 3 and 4), the beam 222 now executes a closed cycle of movements, as illustrated by the closed line on the left in FIGS. 3 and 4. In each cycle of movements, each rod is displaced to the right against the reservoir 131 of the siliconizing device and then once more placed on the slots 210a of the holding part 210.

The workpiece 1 shown in the center portion of FIG. 3 is in a siliconizing step d), also referred to as a silicizing process; it is in position on the roller wicks 132 of the reservoir 131 so that it can be immersed in the molten silicon in the reservoir 131. In a final cycle of the transport step c), it is lowered from the conveying part 220 of the conveyor device 200 onto this roller wick 132.

In the second section of the conveyor device 200 (to the right of the siliconizing device 130 in FIG. 3), step e), the rods 10 are conveyed towards and to the outlet 120. This step is carried out in an analogous manner to step c), as indicated by the closed line on the right in FIG. 3. In this manner, a cycle of movement of the conveying part 220 can comprise transport in the conveying direction by a separation of one pair of slots 210a from the adjacent pair of slots 210a or a multiple of this distance. During step e), the workpieces 1 cool down slowly as they are moved away incrementally from the siliconizing device 130.

FIG. 4 illustrates an alternative embodiment to that of FIG. 3, wherein the heat released in step d) can be used to particular effect. In contrast to the embodiment of FIGS. 2 and 3, in this case the second section of the conveyor device 200 is disposed on the same side of the siliconizing device 130, but below the first section of the conveyor device 200.

In this figure again, the beams 212 of the holding part 210 and the beams 222 of the conveying part 220 are shown with their respective slots 210a, 220a in a position within the closed cycle of movements (closed arrowed line), in which the beam 222 is lifted with respect to the beam 212 and the workpieces 1 are thus in their moving phase in which they are not resting on the holding part 210.

In this embodiment, between the steps c) and d), an intermediate step has to be interposed, wherein those workpieces 1 that are currently in the reservoir 131 of the siliconizing device and their rod 10 are transported downwards onto the second section of the conveyor device 200. This can be carried out by means of the beams 221, 222 of the conveyor device 220 itself or, moreover, by means of a separate mechanism (such as a pair of additional beams for conveying downwards).

The device in accordance with the invention and the method of the invention can provide a siliconizing process with reduced use of materials and also a higher workpiece throughput compared with known methods.

The following is a summary list of reference numerals used in the foregoing description of the exemplary embodiments:
1 workpiece
1a through opening
10 rod
100 chamber
110 inlet
120 outlet
130 siliconizing device
131 reservoir
132 roller wick
200 conveyor device
210 holding part
210a pair of slots
211 first beam
212 second beam
220 conveying part
220a pair of slots
221 first beam
222 second beam

1. An apparatus for siliconizing carbon-containing workpieces, the apparatus comprising:
a siliconizing device disposed inside a chamber, said chamber having an inlet and an outlet;
a conveyor device having a stationary holding part and a conveying part, said stationary holding part extending between said inlet and said siliconizing device and between said siliconizing device and said outlet, and said conveying part including two beams that are movable parallel to one another;
each of said holding part and said conveying part being formed with respective pairs of slots, with said slots of one of each pair facing one another with respect to a longitudinal axis L of said conveyor device and being configured to hold a workpiece or a rod holding the workpiece; and
wherein said conveying part is configured to be driven in a repeated cycle of movements including a lifting movement, an advancing movement, and a lowering movement in order to move rods resting on said holding part in an indexed manner along the longitudinal axis L from said inlet to said siliconizing device, and from said siliconizing device to said outlet.

2. The apparatus according to claim 1, wherein said pairs of slots of said holding part are formed at an equidistant spacing from one another.

3. The apparatus according to claim 1, wherein said holding part comprises beams that are parallel to one another.

4. The apparatus according to claim 3, wherein said conveying part has a first beam extending in a direction adjacent a first beam of said holding part and said conveying part has a second beam extending in a same direction adjacent a second beam of said holding part.

5. The apparatus according to claim 1, wherein the cycle of movements is a closed cycle in the following sequential order: lifting, advancing, lowering, and returning.

6. The apparatus according to claim 1, wherein a first section of said holding part, which extends between the inlet and said siliconizing device, is spatially disposed above a second section which extends between said siliconizing device and said outlet.

7. The apparatus according to claim 1, wherein said siliconizing device comprises a reservoir in which two roller wicks are positioned, and wherein said conveyor device is configured to place a rod resting on said holding part between said roller wicks in one movement cycle, and to place the rod on the holding part in a subsequent movement cycle.

8. The apparatus according to claim 1, wherein the siliconizing device comprises a reservoir in which a plurality of stationary wicks are positioned, and wherein said conveyor device is configured to position one or more workpieces resting on the holding part onto the stationary wicks in one movement cycles and to take the one or more workpieces up and and place the one or more workpieces on the holding part in a subsequent movement cycle.

9. A method for siliconizing carbon-containing workpieces, comprising:
a) placing one or more workpieces on a rod;
b) resting the rod on a pair of slots of a conveyor device, the conveyor device having a stationary holding part that extends from an inlet of a siliconizing chamber to a siliconizing device in the siliconizing chamber and from the siliconizing device to an outlet of the siliconizing chamber, and having a conveying part with two beams that can move parallel to one another;
c) conveying the rod by single or repeated lifting, advancing and lowering the rod with the conveying part on the holding part, to thereby transport the rod incrementally from the inlet into the siliconizing device;
d) siliconizing the workpiece in the siliconizing device; and
e) conveying the rod by repeated lifting, advancing and lowering the rod with the conveying part on the holding part to thereby transport the rod incrementally away from the siliconizing device to the outlet.

10. The method according to claim 9, wherein in steps c) and e), the cycles of the lifting, advancing and lowering movements are mutually identical.

11. The method according to claim 9, which comprises providing for closed movement cycles including a lifting movement, an advancing movement, a lowering movement, and a return movement of the beams of the conveying part in the sequence, and wherein during the return movement of the beams, the rod is accommodated in a pair of slots of the holding part.

12. The method according to claim 9, wherein the siliconizing device contains a reservoir filled with molten silicon, and wherein the transport into the siliconizing device comprises lowering the workpieces placed on the rod down onto roller wicks inside the reservoir.

13. The method according to claim 9, wherein step a) comprises guiding the rods through a through opening of the workpiece.

14. The method according to claim 13, which comprises placing a sleeve formed from silicon-repellent material between the rod and the workpiece.

15. The method according to claim 9, which comprises carrying out step e) in a region that is spatially below a region in which step c) is carried out.
